(19) United States
(12) Patent Application Publication
(10) Pub. No.: US 2012/0233035 A1
(43) Pub. Date: Sep. 13, 2012

(54) System, Method and Apparatus for Matching Sales Leads to Purchases

(75) Inventors: Mark Beaman Wilgus, Colleyville, TX (US); Charles Derrick White, Bedford, TX (US)

(73) Assignee: Supplylogix, LLC., Westlake, TX (US)

(21) Appl. No.: 13/412,806

(22) Filed: Mar. 6, 2012

Related U.S. Application Data
(60) Provisional application No. 61/450,068, filed on Mar. 7, 2011.

(51) Int. Cl. G06Q 30/00

(52) U.S. Cl. 705/27.1

(57) ABSTRACT

A system, apparatus and method matches sales leads to purchases by receiving product inventory data, normalizing the received product inventory data, and storing the normalized product inventory data a database. A product availability query is received that includes a requested product and a location. Search results are obtained by searching the database for normalized product inventory data that best matches the requested product and the location. The search results are provided to the potential customer, and the product availability query and the search results are stored in the database. Product sales data is received from the vendor, and the received product sales data is stored in the database. A determination is then made whether a product sale resulted from the product availability query by calculating a match score based on the stored product sales data, the stored product availability queries and the stored search results.

### PRIORITY CLAIM

This patent application is a non-provisional patent application of U.S. provisional patent application Ser. No. 61/450,068 filed on Mar. 7, 2011 and entitled “System, Method and Apparatus for Matching Sales Leads to Purchases,” which is hereby incorporated by reference in its entirety.

### FIELD OF THE INVENTION

The present invention relates generally to the field of product inventory and sales and, more particularly, to a system, method and apparatus for matching sales leads to purchases.

### BACKGROUND OF THE INVENTION

Accurately matching sales leads to purchases is extremely valuable, but has proven to be elusive despite advances in technology, customer tracking and online purchasing. Most systems are either inaccurate, rigid or require large amounts of personal information in order to match sales leads to purchases. As a result, there is a need for a system that more accurately matches sales leads to purchases.

### SUMMARY OF THE INVENTION

The present invention provides a flexible, multipurpose system, designed to provide maximum flexibility for data consumers while requiring the smallest amount of personal information to make a successful search.

More specifically, the present invention provides a method for providing product availability information to a potential customer using a computer having an interface, a database and a processor communicably coupled to the interface and one or more databases. Product inventory data is received from a vendor via the interface, the received product inventory data is normalized, and the normalized product inventory data is stored in the database(s). A product availability query is received from the potential customer via the interface. The product availability query includes a requested product and a location. One or more search results are obtained by searching the database(s) for the normalized product inventory data that best matches the requested product and the location. The search results are provided to the potential customer via the interface, and the product availability query and the search results are stored in the database(s). Product sales data is received from the vendor, and the received product sales data is stored in the database(s). A determination is then made whether a product sale resulted from the product availability query by calculating a match score based on the stored product sales data, the stored product availability queries and the stored search results. The match score is provided to the vendor. The foregoing method can be implemented as a computer program embodied on a non-transitory computer readable medium for execution by a computer or processor such that the steps are implemented as one or more code segments.

In addition, the present invention provides an apparatus that includes a communications interface, a memory, a database, and a processor communicably coupled to the communications interface, the memory and the database. The processor receives product inventory data from a vendor via the communications interface, normalizes the received product inventory data, stores the normalized product inventory data in the database(s), and receives a product availability query from the potential customer via the communications interface. The product availability query includes a requested product and a location. The processor obtains one or more search results by searching the database(s) for normalized product inventory data that best matches the requested product and the location, provides the search results to the potential customer via the communications interface, and stores the product availability query and the search results in the database(s). The processor receives a product sales data from the vendor, stores the received product sales data in the database(s), determines whether a product sale resulted from the product availability query by calculating a match score based on the stored product sales data, the stored product availability queries and the stored search results, and provides the match score to the vendor.

The present invention also provides a system that includes one or more potential customer devices, one or more vendor devices, one or more communication networks, and a data processing device. The data processing device includes a communications interface communicably coupled to the one or more potential customer devices and the one or more vendor devices via the one or more communication networks, a memory, a database, and a processor communicably coupled to the communications interface, the memory and the database. The processor receives a product inventory data from the vendor device via the communications interface, normalizes the received product inventory data, stores the normalized product inventory data in the database(s), and receives a product availability query from the potential customer device via the communications interface. The product availability query includes a requested product and a location. The processor obtains one or more search results by searching the database(s) for normalized product inventory data that best matches the requested product and the location, provides the search results to the potential customer device via the communications interface, and stores the product availability query and the search results in the database(s). The processor receives a product sales data from the vendor device, stores the received product sales data in the database(s), determines whether a product sale resulted from the product availability query by calculating a match score based on the stored product sales data, the stored product availability queries and the stored search results, and provides the match score to the vendor device.

In one embodiment of the present invention, retail pharmacy clients provide inventory position data in a near real-time format. This data is then disseminated to a wide variety of applications, clearinghouses and websites (data consumers) designed to make the inventory data available to as many end consumers and prescription writers (potential sales leads) as possible. The present invention analyzes where and how the sales leads were provided, what sales have taken place at the client locations and provide the clients with a sliding score of between 0 and 100 (lead-to-purchase (L2P) Score) for each lead. This L2P Score represents the likelihood that inventory data was a factor in the purchase and the clients pay a variable fee per lead provided depending on this score. Pharmacies are a unique retail environment where state and federal law require specific information about each product dispensed (sales transaction) to be stored electronically. The present invention is, however, beneficial to other retail environments.

The present invention is described in detail below with reference to the accompanying drawings.

### BRIEF DESCRIPTION OF THE DRAWINGS

The above and further advantages of the invention may be better understood by referring to the following description in conjunction with the accompanying drawings, in which:

FIG. 1 is a block diagram of a lead-to-purchase system in accordance with one embodiment of the present invention;

FIG. 2 is a flow chart of a lead-to-purchase process in accordance with one embodiment of the present invention;

FIG. 3 is a block diagram of a lead-to-purchase system in accordance with another embodiment of the present invention;

FIGS. 4-8 are flow charts of a pharmaceutical lead-to-purchase process in accordance with another embodiment of the present invention; and

FIGS. 9 and 10A-10F are illustrations of screen shots an application program interface for a pharmaceutical lead-to-purchase system in accordance with another embodiment of the present invention.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention. The discussion herein relates primarily to pharmacies and pharmaceutical products, but it will be understood that the concepts of the present invention are applicable to any sales environment and type of product.

In one embodiment of the present invention, retail pharmacy clients provide inventory position data in a near real-time format. This data is then disseminated to a wide variety of applications, clearinghouses and websites (data consumers) designed to make the inventory data available to as many end consumers and prescription writers (potential sales leads) as possible. The present invention analyzes where and how the sales leads were provided, what sales have taken place at the client locations and provide the clients with a sliding score of between 0 and 100 (lead-to-purchase (L2P) Score) for each lead. This L2P Score represents the likelihood that inventory data was a factor in the purchase and the clients pay a variable fee per lead provided depending on this score. Pharmacies are a unique retail environment where state and federal law require specific information about each product dispensed (sales transaction) to be stored electronically. The present invention is, however, beneficial to other retail environments.

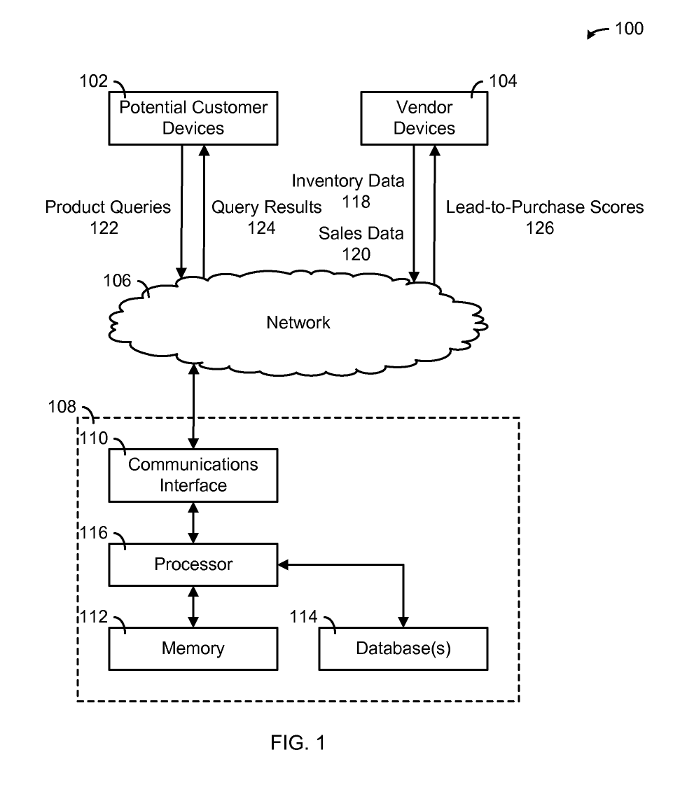

Referring now to FIG. 1, a block diagram of a lead-to-purchase system 100 in accordance with one embodiment of the present invention is shown. The system 100 includes one or more potential customer devices 102, one or more vendor devices 104, one or more communication networks 106 and a data processing device 108. The one or more potential customer devices 102 may include a computer, a laptop, a server, a handheld computer, a mobile communications device, or any other device in which a potential customer (e.g., a partner, a third-party application, a clearinghouse, a third-party website, an individual, etc.) can communicate with the data processing device 108. The one or more vendor devices 104 may include a computer, a laptop, a server, or any other device in which a vendor (e.g., retailer, wholesaler, a manufacturer, a distributor, etc.) provides the required information to the data processing device 108. The one or more communications networks 106 may include a local area network, a wide area network, a hardline connection, a wireless connection, a satellite connection, a point-to-point connection, the Internet, a private network, a service provider's network, any other means of transmitting data, or any combination thereof.

The data processing device 108 includes a communications interface 110, a memory 112, one or more databases 114, and a processor 116. The communications interface 110 is communicably coupled to the one or more potential customer devices 102 and the one or more vendor devices 104 via the one or more communication networks 106. The communications interface 110 can be multiple interfaces, such as a query interface and a data interface. The processor 116 is communicably coupled to the communications interface 110, the memory 112 and the database(s) 114. The databases 114 may include multiple databases (e.g., a first database for the normalized product inventory data, a second database for the product sales data, and a third database for the product availability queries and the search results). The databases 114 can be integrated into the same device as the processor 116, located locally and communicably connected to the processor 116, located remotely and communicably connected to the processor 116, or a combination thereof. Moreover, the present invention may include redundant devices or devices operating in parallel. The vendor devices 104 provide inventory data 118 and sales data 120 to the data processing device 108 for analysis and storage in the database(s) 114. The inventory data 118 and sales data 120 can be provided in real-time or near real-time. The product inventory data 118 may include a product name or code and a quantity available. The sales data 120 may include the product name or code, a customer identifier, a sales date and a quantity sold. The potential customer devices 102 submit product queries 122 which are processed by the processor 116. The product availability query 122 may include a requested product, a location (e.g., a zip code, an address, a GPS coordinate, a latitude and a longitude, etc.), a quantity, a session identifier and one or more access keys. The processor 116 then provides search results 124 to the potential customer devices 102 based on the inventory data 118 stored in the database(s) 114. The search results 124 can be ranked on the location, a quantity available, a price or a combination thereof. Thereafter, the processor 116 analyzes the product queries 122, the query results 124 and the sales data 120 to generate a lead-to-purchase score 126. The lead-to-purchase score 126 represents the likelihood that inventory data was a factor in the purchase. The lead-to-purchase score 126 can be based on any scale (e.g., 0-100 where 0 indicates no match, and 100 indicates a certain match). In one embodiment, the vendors pay a variable fee per lead provided depending on this score.

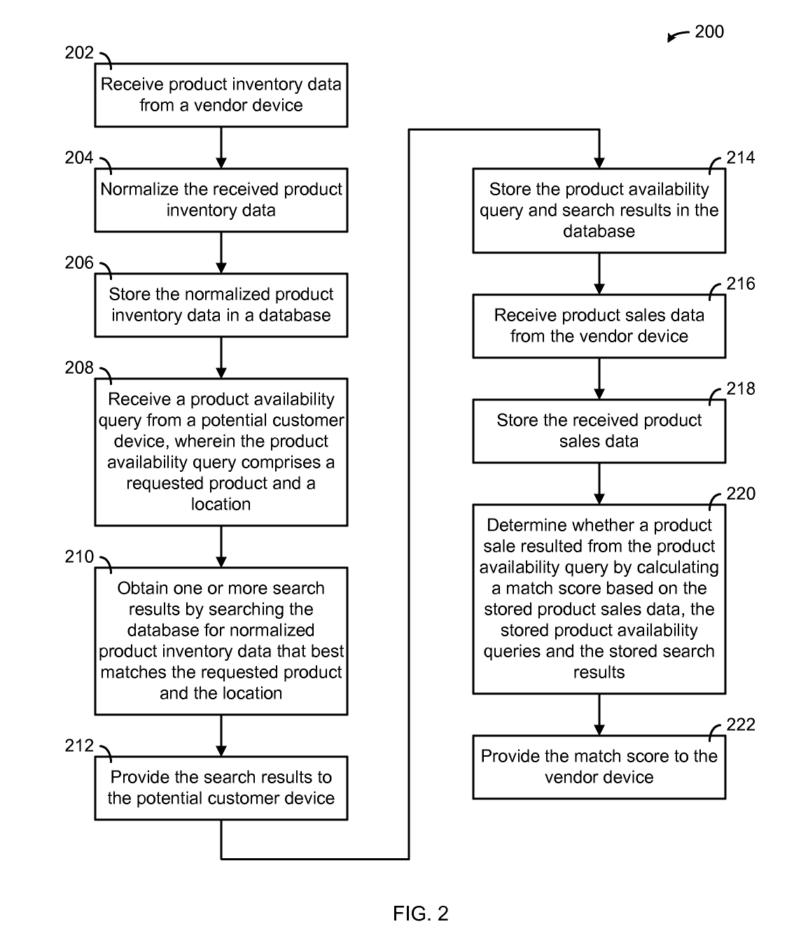

Now referring to FIG. 2, a flow chart of a lead-to-purchase process 200 in accordance with one embodiment of the present invention is shown. The lead-to-purchase process 200 can be implemented in, but is not limited to, the system 100 of FIG. 1. The processor 116 receives product inventory data 118 from the vendor device 104 via the communications interface 110 in block 202, normalizes the received product inventory data 118 in block 204 and stores the normalized product inventory data in the database(s) 114 in block 206. The processor 116 receives a product availability query 122 from the potential customer device 102 via the communications interface 110 in block 208. The product availability query 122 may include a requested product and a location. The processor 116 obtains one or more search results 124 by searching the database(s) 114 for normalized product inventory data that best matches the requested product and the location in block 210 and provides the search results 124 to the potential customer device 102 via the communications interface 110 in block 212. The processor 116 stores the product availability query 122 and the search results 124 in the database(s) 114 in block 214. The processor 116 receives product sales data 120 from the vendor device 104 in block 216 and stores the received product sales data 120 in the database(s) 114 in block 218. The processor 116 determines whether a product sale resulted from the product availability query 122 by calculating a match score 126 in block 220 and provides the match score 126 to the vendor device 104 in block 222. The match score or lead-to-purchase score 126 is based on the stored product sales data 120, the stored product availability queries 122 and the stored search results 124. The process 200 can be implemented as a computer program embodied on a non-transitory computer readable medium for execution by a computer or processor such that the steps are implemented as one or more code segments.

In addition, the process 200 can also check the product availability query 122 for missing data or errors, and notify the potential customer 102 of the missing data or errors via the interface. The process 200 can exclude any sensitive data from the received product inventory data 118 or any personal information about the customer from the sales data 120. As a result, the present invention complies with applicable state and federal regulations, including but not limited to, HIPPA. A quantity of a product in inventory can be converted to an inventory level comprising a high level, a medium level, a low level and an out-of-stock level. Finally, a fee can be received from the vendors based on the match score 126 whenever the potential customer 102 is a new customer or an existing customer purchasing a new product.

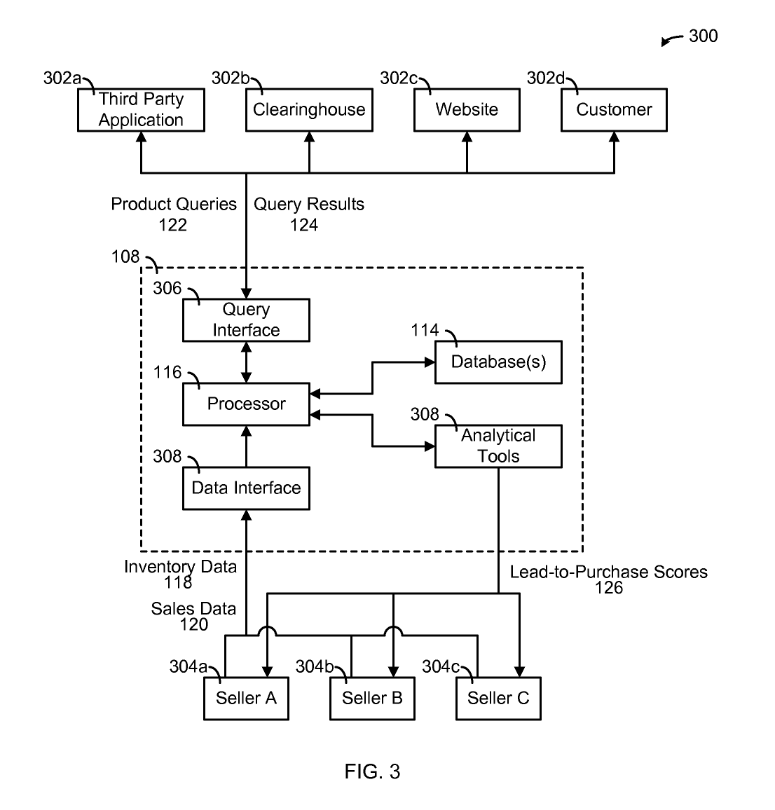

Referring now to FIG. 3, a block diagram of a lead-to-purchase system 300 in accordance with another embodiment of the present invention is shown. The system 300 includes one or more potential customers 302, one or more vendors 304 and a data processing device 108. The one or more potential customers 302 may include a third-party application 302a, a clearinghouse 302b, a website 302c or a customer (individual) 302d. The one or more vendors 304 (Seller A 304a, Seller B 304b and Seller C 304c) provide the required information to the data processing device 108. The data processing device 108 includes a query interface 306, a data interface 308, one or more databases 114, one or more analytical tools 308 and a processor 116. The processor 116 is communicably coupled to the query interface 306, the data interface 308, the database(s) 114 and the analytical tool(s) 308. The databases 114 may include multiple databases (e.g., a first database for the normalized product inventory data, a second database for the product sales data, and a third database for the product availability queries and the search results). The databases 114 can be integrated into the same device as the processor 116, located locally and communicably connected to the processor 116, located remotely and communicably connected to the processor 116, or a combination thereof. Moreover, the present invention may include redundant devices or devices operating in parallel. The vendors 304 provide inventory data 118 and sales data 120 to the data processing device 108 for analysis and storage in the database(s) 114 via the data interface 308. The inventory data 118 and sales data 120 can be provided in real-time or near real-time. The product inventory data 118 may include a product name or code and a quantity available. The sales data 120 may include the product name or code, a customer identifier, a sales date and a quantity sold. The potential customers 302 submit product queries 122 which are processed by the processor 116 via the query interface 306. The product availability query 122 may include a requested product, a location (e.g., a zip code, an address, a GPS coordinate, a latitude and a longitude, etc.), a quantity, a session identifier and one or more access keys. The processor 116 then provides search results 124 to the potential customer devices based on the inventory data 118 stored in the database(s) 114 via the query interface 306. The search results 124 can be ranked on the location, a quantity available, a price or a combination thereof. Thereafter, the processor 116 analyzes the product queries 122, the query results 124 and the sales data 120 to generate a lead-to-purchase score 126. The lead-to-purchase score 126 represents the likelihood that inventory data 118 was a factor in the purchase. The lead-to-purchase score 126 can be based on any scale (e.g., 0-100 where 0 indicates no match, and 100 indicates a certain match). In one embodiment, the vendors pay a variable fee per lead provided depending on this score.

The present invention provides a flexible, multipurpose system, designed to provide maximum flexibility for data consumers while requiring the smallest amount of personal information to make a successful search. An example of such a system designed for pharmacies and pharmaceuticals will now be described.

A data consumer partner enrolls in the L2P system through an external process. At that point, security keys are created that allow the partner to access the present invention's inventory API and begin using the drug search capability. In order to create a successful search, the partner provides search data as outlined in the API documentation, but at a minimum the drug name or NDC, geographical coordinates, a session ID and access control keys are needed.

At the point the search criteria is submitted to the API, the present invention normalizes the query such that:
1. In the case of branded drugs without generics available, the search is performed across all available pack sizes.
2. In the case of branded drugs with generics available or a generic drug search, the data is normalized to all therapeutically equivalent generics, and the search is performed across all available brands (if available), generics and all available pack sizes of all of these.
3. If a brand is available in a given store, the system will return “brand available” if the inventory level is greater than the most commonly dispensed unit quantity (MCDUQ), “brand low stock” if the inventory level is between 1 and the MCDUQ, and “brand out of stock” if the inventory level is below 1.
4. If a generic is available in a given store, the system will return a similar response to the brand results for each inventory position “generic available” “generic low stock” and “generic out of stock”.
   If results are available, the API will return up to 100 stores nearest the geographical coordinates provided in the search specification. The results are prioritized according to the likelihood that pharmacy has the drug in stock and the distance from the searching location.

The L2P Score is a multivariate statistical ranking system that ranks the likelihood that a sales lead from inventory information provided via the present invention's API resulted in a sale at a client pharmacy. The L2P Score ranges between 0 (no candidate sales transaction linked) and 100 (candidate sales transaction almost certainly result of L2P lead in question.)

The specific data elements received from retail clients in order to track possible sales are illustrated below. Dispensing data is the most important element considered when determining the likelihood the L2P lead ultimately resulted in a sale by the client pharmacy. The dispense data includes key data elements such as product dispensed, a unique anonymous patient identifier, and when the transaction occurred.

Additionally, the L2P Score may consider the following additional variables in its statistical calculation:
Data consumer type (e-prescribing system vendor, consumer website, medical professional website, etc.);
Time between the original search results and the candidate sales transaction;
Whether the candidate sales transaction was for a new or existing patient;
Baseline frequency of new fills for the drug involved in the sales transaction at the store;
Refill number of the candidate sales transaction;
Whether there was a click-through, e-prescribing or other indicating event linked to the pharmacy involved in the candidate sales transaction;
The quality of the search user, defined as the likelihood the search was initiated by a human (versus a device generated or bot query);
The previous quality of search users from the originating data consumer partner; and
Whether the supplied “session user” has been involved in a previously successful opportunity.
   Other variables can be added from time to time to improve the quality of the L2P Score.

The local drug inventory data is available to e-prescribing applications, provider and consumer web sites and other selected partners via a REST API, http://api.supplylogix.com/drugsearch/ The query uses the following values:

| Parameters | Description |
|---|---|
| term | This can be any of the following values: |
| | 11-digit full NDC |
| | 9-digit partial NDC |
| | Partial drug name (Optional: drug strength) |
| | (Required) |
| geo | Geographical search location, this can be any of |
| | the following values: |
| | city, state and zip code |
| | zip code only |
| | latitude + longitude |
| | (Required) |
| daw | The “dispense as written” flag; indicates the |
| | query should only return results for the specific |
| | drug being queried (subject to package size |
| | variations). No therapeutically equivalent |
| | generics will be returned in the results set. |
| | (Optional) |
| start_index | The zero-based offset into the results of the |
| | query. When used with the max_results |
| | parameter, you can request successive pages of |
| | search results. |
| | (Optional) |
| max_results | The maximum number of results to return. This |
| | number cannot be greater than 100. If |
| | max_results is not specified, the default value is |
| | 25. |
| | (Optional) |
| session_user | Identifier that uniquely correlates to the partner's |
| | end consumer of the results set (for example, |
| | unique website user or application login.) |
| | (Optional) |
| OAuth Access | Consumer key + signature |
| Control | (Required) |

The query response returns one of the following:

1. If a drug name is supplied and there are multiple drug strengths available, the present invention will return a listing of possible options to help refine the query. Example:

If a user queries for “Enbrel”, there are at least two options available: 20 mg and 50 mg. The present invention will return both options with links to the final results set for each option.

2. If a valid unique drug, drug and strength, or 9 or 11-digit NDC is supplied, an example of the XML encoded results set layout is as follows:

<search_results>

<serial>1bcf4368343a43b58efa</serial>
<number_of_results>120</number_of_results>
<start_index>0</start_index>
<results_per_page>10</results_per_page>
<pharmacy_result>

<id>http://api.supplylogix.com/pharmacies/543455664</id>
<store_logo>http://api.supplylogix.com/images/hlthdrug.png</store_logo>
<store_name>Healthy Drug #15</store_name>
<store_address1>308 Crestwood Dr</store_address1>
<store_city>Fort Worth</store_city>
<store_state>TX</store_state>
<store_zip>76107</store_zip>
<store_phone>817-100-1000</store_phone>
<brand_instock>Yes</brand_instock>
<generic_instock>Not Available</generic_instock>
<customer_distance>0.45mi</customer_distance>

</pharmacy_result>
<pharmacy_result>

<id>http://api.supplylogix.com/pharmacies/543455678</id>
<store_logo>http://api.supplylogix.com/images/hlthdrug.png</store_logo>
<store_name>Healthy Drug #12</store_name>
<store_address1>301 Commerce Street</store_address1>
<store_city>Fort Worth</store_city>
<store_state>TX</store_state>
<store_zip>76107</store_zip>
<store_phone>817-100-2000</store_phone>
<brand_instock>Low</brand_instock>
<generic_instock>Not Available</generic_instock>
<customer_distance>0.75mi</customer_distance>

</pharmacy_result>

</search_results>

3. The present invention will return an appropriate error condition if the search parameters are invalid or there are no matching pharmacies or drugs to the query.

Pharmacy partners may submit dispense data history for the purposes of L2P scoring via a REST API, http://api.supplylogix.com/dispense/ This data should be provided net of any processed credit returns and is submitted using the following values:

| Parameters | Description |
|---|---|
| npi | Pharmacy National Provider Identifier |
| fill_date | Date/time of dispense record in YYYY-MM- |
| | DDTHH:MM:SS |
| | (Required) |
| ndc | 11-digit National Drug Code Identifier of |
| | dispensed drug |
| | (Required) |
| quantity_dispensed | Units of drug dispensed. |
| | (Required) |
| fill_number | Fill indicator number. The initial fill is identified |
| | as “0”. |
| | (Required) |
| patient_code | A unique anonymous identifier of the patient |
| | receiving the drug. At a minimum this identifier |
| | must be unique and consistent within the |
| | pharmacy. The present invention may return this |
| | value as part of the opportunity identification |
| | process. |
| | (Required) |
| OAuth Access Control | Consumer key + signature |
| | (Required) |

Pharmacy partners may submit QOH inventory data history via a REST API, http://api.supplylogix.com/qoh/ This data should be provided on an at least daily basis, and should be net of any pending sales, transfers or credit returns. It should accurately reflect actual inventory on-hand and available for sale at the time it is submitted to the present invention. The data is submitted using the following values:

| Parameters | Description |
|---|---|
| npi | Pharmacy National Provider Identifier or NCPDP |
| | number |
| | (Required) |
| ndc | 11-digit National Drug Code Identifier of |
| | dispensed drug |
| | (Required) |
| quantity_onhand | Current position of that drug within the |
| | pharmacy, net of all pending adjustments and |
| | credit returns. |
| | (Required) |
| OAuth Access Control | Consumer key + signature |
| | (Required) |

Partners using the present invention may submit post-query disposition information via a REST API, http://api.supplylogix.com/pqd This data set is optional but may improve the quality of the L2P score assigned to the related queries. This data is submitted using the following values:

| Parameters | Description |
|---|---|
| search_serial | Search serial number originally returned in the |
| | drug search results set. |
| | (Required) |
| activity_npi | Pharmacy National Provider Identifier that |
| | received post query activity. |
| | (Required) |
| activity_type | Activity detected on the basis of the results set. |
| | Values include: |
| | “Click_thru” pharmacy demographic details are |
| | requested |
| | “Escript_sent” pharmacy is sent an e-script |
| | (Required |
| OAuth Access Control | Consumer key + signature |
| | (Required) |

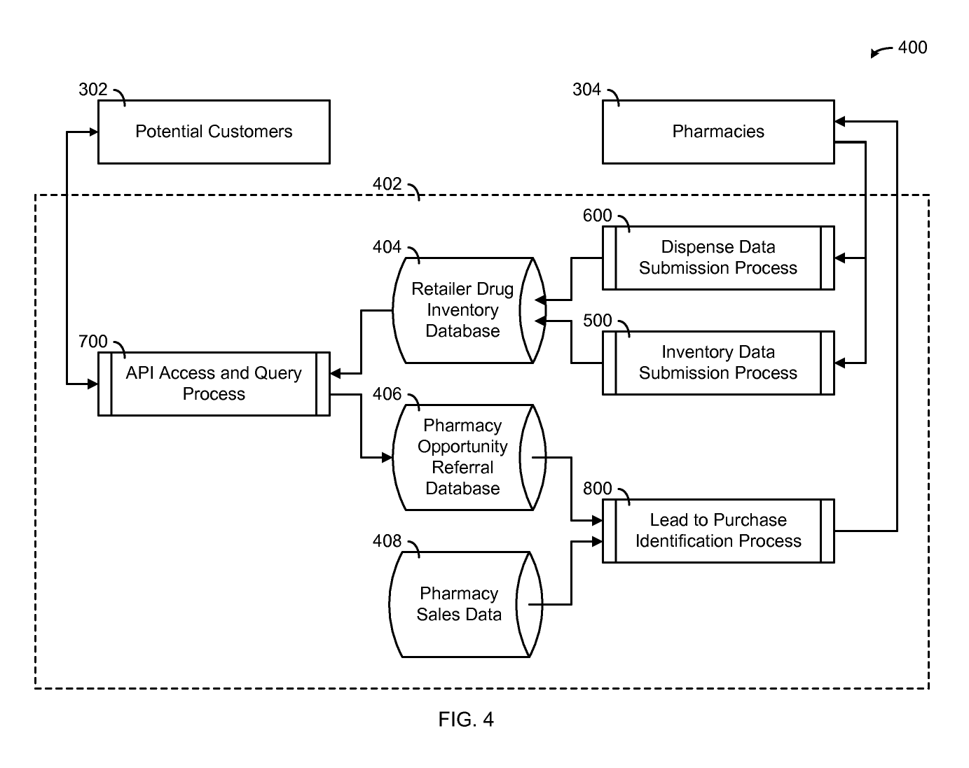

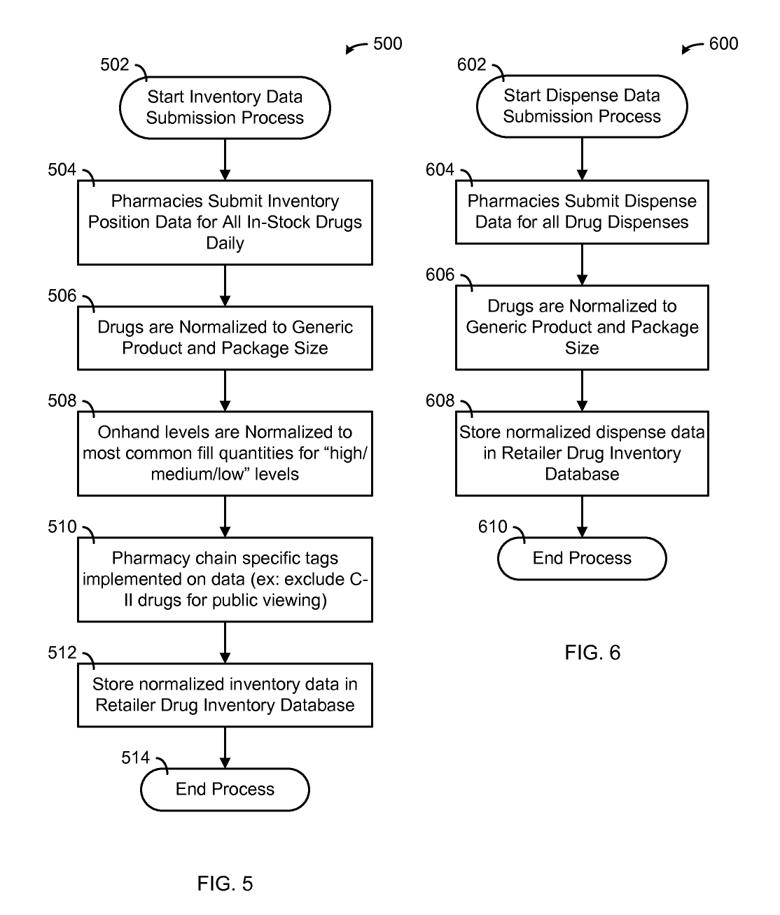

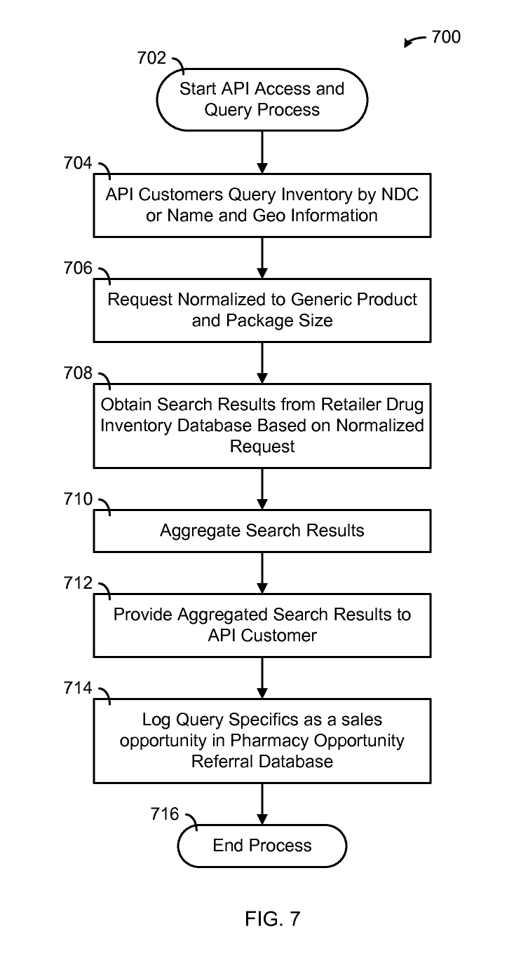

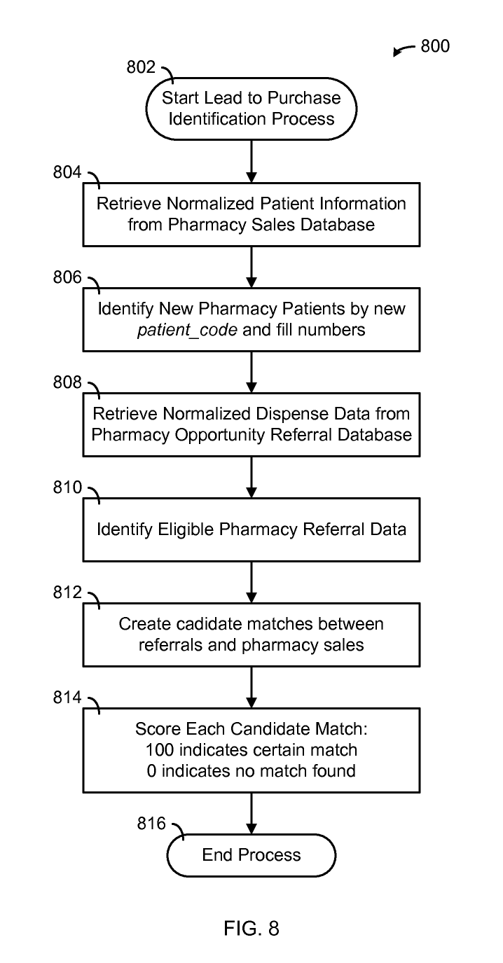

Now referring to FIGS. 4-8, flow charts of a pharmaceutical lead-to-purchase process 400 in accordance with another embodiment of the present invention is shown. As shown if FIG. 4, Potential Customers 302 and Pharmacies 304 communicate with a pharmaceutical lead-to-purchase system 402, which includes various processes (500, 600, 700 and 800) and databases (404, 406 and 408). The Inventory Data Submission Process 500 (see FIG. 5) interacts with the Pharmacies 304 and the Retailer Drug Inventory Database 404. The Dispense Data Submission Process 600 (see FIG. 6) interacts with the Pharmacies 304 and the Retailer Drug Inventory Database 404. The API Access and Query Process 700 (see FIG. 7) interacts with the Potential Customers 302, the Retailer Drug Inventory Database 404 and the Pharmacy Opportunity Referral Database 406. The Lead to Purchase Identification Process 800 (see FIG. 8) interacts with the Pharmacies 304, the Pharmacy Opportunity Referral Database 406 and the Pharmacy Sales Database 408.

As shown in FIG. 5, the Inventory Data Submission Process 500 begins in block 502. Pharmacies 304 submit inventory position data for all in-stock drugs on a daily basis in block 504. The drugs are normalized to generic product and package size in block 506. The onhand levels are normalized to the most common fill quantities for “high/medium/low” levels in block 508. Pharmacy chain specific tags are implemented on the data (e.g., C-II drugs are excluded for public viewing) in block 510. The normalized inventory data is stored in the Retailer Drug Inventory Database 404 in block 512 and the process ends in block 514.

As shown in FIG. 6, the Dispense Data Submission Process 600 begins in block 602. Pharmacies 304 submit dispense data for all drug dispenses in block 604. The drugs are normalized to generic product and package size in block 606. The normalized dispense data is stored in the Retailer Drug Inventory Database 404 in block 608 and the process ends in block 610.

As shown in FIG. 7, the API Access and Query Process 700 begins in block 702. API Customers 302 query the inventory by NDC or Name and geographic information in block 704. The request is normalized to generic product and package size in block 706. The search results are obtained from the Retailer Drug Inventory Database 404 based on the normalized request in block 708 and the search results are aggregated in block 710. The aggregated search results are provided to the API Customer 302 in block 712. The query specifics are logged as a sales opportunity in the Pharmacy Opportunity Referral Database 406 in block 714 and the process ends in block 716.

As shown in FIG. 8, the Lead to Purchase Identification Process 800 begins in block 802. The normalized patient information is retrieved from the Pharmacy Sales Database 408 on block 804. New pharmacy patients are identified by new patient code and fill numbers in block 806. The normalized dispense data is retrieved from the Pharmacy Opportunity Referral Database 406 in block 808. Eligible pharmacy referral data is identified in block 810 and candidate matches are created between referrals and pharmacy sales in block 812. Each candidate match is scored (100 indicates certain match; and 0 indicates no match found) in block 814 and the process ends in block 816.

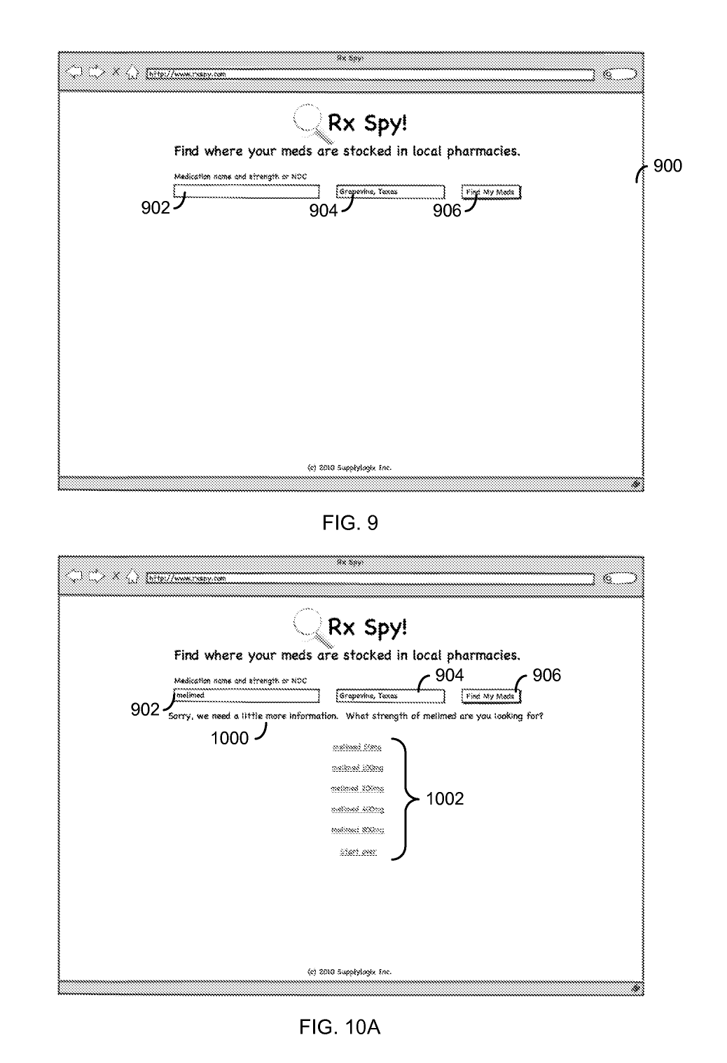

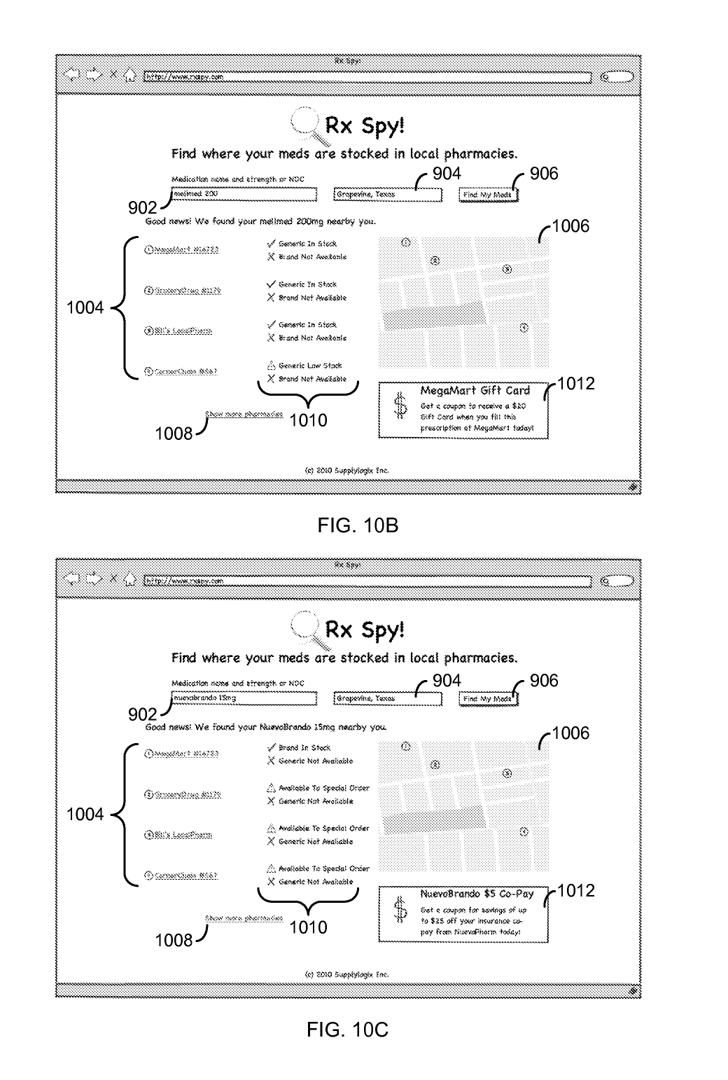

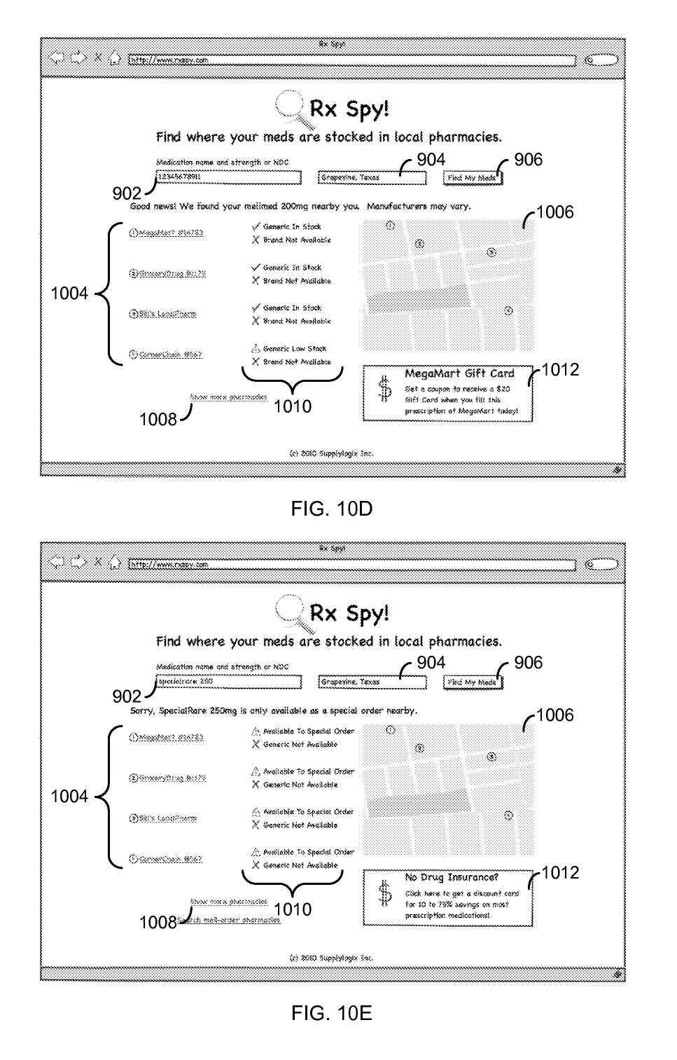

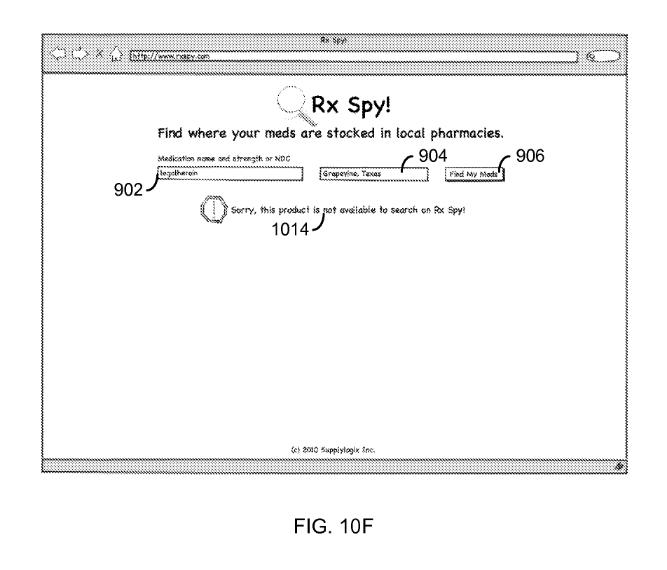

FIGS. 9 and 10A-10F are illustrations of screen shots an application program interface for a pharmaceutical lead-to-purchase system in accordance with another embodiment of the present invention. FIG. 9 shows a search or query screen 900 for use by a potential customer via a potential customer device 102. The query screen 900 includes a query field 902 in which the potential customer enters the requested product, a location field 904 in which the potential customer enters a location for the search, and an execute icon, button or field 906 that the potential customer uses to initiate the search.

FIG. 10A shows an example in which a potential customer submitted a search for “melimed” (902) in “Grapevine, Tex.” (904) that did not contain sufficient information to return any search results or would return too many search results. The potential customer is notified of this fact with the message 1000 “Sorry, we need a little more information. What strength of melimed are you looking for?” The potential customer is also provided with a list of responses 1002 to select from: “melimed 50 mg”; “melimed 100 mg”; “melimed 200 mg”; “melimed 400 mg”; “melimed 800 mg” or “Start over”. If the potential customer selected “melimed 200 mg”, the screen shown in FIG. 10B would provide the search results. A number of vendors 1004 are shown as well as a map 1006 indicating the location of the vendors 1004. Additional vendors (if any) can be displayed by clicking or selection the icon, button or field 1008. In addition, an indication 1010 of the availability of the pharmaceutical is shown. For example, the generic is in stock at vendors 1, 2 and 3, and is in low stock at vendor 4; and the brand name is not available at any of the locations. Coupons, advertisements or other information 1012 can also be displayed. FIGS. 10C-10E show examples of other searches and search results. FIG. 10F show an example where the pharmaceutical was not found and a notification 1014 is provided to the potential customer.

It will be understood by those of skill in the art that information and signals may be represented using any of a variety of different technologies and techniques (e.g., data, instructions, commands, information, signals, bits, symbols, and chips may be represented by voltages, currents, electromagnetic waves, magnetic fields or particles, optical fields or particles, or any combination thereof). Likewise, the various illustrative logical blocks, modules, circuits, and algorithm steps described herein may be implemented as electronic hardware, computer software, or combinations of both, depending on the application and functionality. Moreover, the various logical blocks, modules, and circuits described herein may be implemented or performed with a general purpose processor (e.g., microprocessor, conventional processor, controller, microcontroller, state machine or combination of computing devices), a digital signal processor (“DSP”), an application specific integrated circuit (“ASIC”), a field programmable gate array (“FPGA”) or other programmable logic device, discrete gate or transistor logic, discrete hardware components, or any combination thereof designed to perform the functions described herein. Similarly, steps of a method or process described herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. Although preferred embodiments of the present invention have been described in detail, it will be understood by those skilled in the art that various modifications can be made therein without departing from the spirit and scope of the invention as set forth in the appended claims.

What is claimed is:

1. A method for matching sales leads to purchases using a computer having an interface, a database and a processor communicably coupled to the interface and one or more databases, the method comprising the steps of:
receiving a product inventory data from a vendor via the interface;
normalizing the received product inventory data;
storing the normalized product inventory data in the database(s);
receiving a product availability query from a potential customer via the interface,
wherein the product availability query comprises a requested product and a location;
obtaining one or more search results by searching the database(s) for the normalized product inventory data that best matches the requested product and the location;
providing the search results to the potential customer via the interface;
storing the product availability query and the search results in the database(s);
receiving a product sales data from the vendor;
storing the received product sales data in the database(s);
determining whether a product sale resulted from the product availability query by calculating a match score based on the stored product sales data, the stored product availability queries and the stored search results; and
providing the match score to the vendor.

2. The method as recited in claim 1, wherein:
the potential customer comprises a customer partner, a third party application, a clearinghouse, a third party website or an individual;
the interface comprises a query interface and a data interface;
the product availability query further comprises a quantity, a session identifier and one or more access control keys;
the vendor comprises a retailer, a wholesaler, a manufacturer or a distributor;
the database comprises a first database for the normalized product inventory data, a second database for the product sales data, and a third database for the product availability queries and the search results;
the product inventory data comprises a product name and a quantity available;
the requested product comprises the product name and a requested quantity;
the location comprises a zip code, an address, a GPS coordinate, or a latitude and a longitude;
the product sales data comprises the product name, a customer identifier, a sales date and a quantity sold; or
the match score comprises a number between 0 and 100 wherein 0 indicates no match found and 100 indicates a match was found with certainty.

3. The method as recited in claim 1, wherein the search results are ranked based on the location, a quantity available or a combination thereof.

4. The method as recited in claim 1, wherein the product inventory data and the product sales data are received in real-time or near real-time.

5. The method as recited in claim 1, wherein the product sales data does not include any personal data.

6. The method as recited in claim 1, further comprising the steps of:
checking the product availability query for missing data or errors; and
notifying the potential customer of the missing data or errors via the interface.

7. The method as recited in claim 1, wherein the database(s) comprise an inventory database, an opportunity referral database and a sales database.

8. The method as recited in claim 1, further comprising the step of excluding any sensitive data from the received product inventory data.

9. The method as recited in claim 1, further comprising the step of converting a quantity of a product in inventory to an inventory level comprising a high level, a medium level, a low level and an out-of-stock level.

10. The method as recited in claim 1, further comprising the step of receiving a fee based on the match score whenever the potential customer is a new customer or an existing customer purchasing a new product.

11. The method as recited in claim 1, wherein the match score is further based on:
a data consumer type;
a time between the search results and the product sale;
whether the product sale was for a new customer or an existing customer;
a frequency of sales for a product;
a number of refills for the product;
whether the product sale was preformed via a click-through event or an electronic transaction event;
whether the product availability query was generated by a device or a person;
whether previous product availability queries from the potential customer have been generated by a device or a person; or
whether the potential customer has previously been determined to purchase a product.

12. The method as recited in claim 1, wherein all communications with the interface are encrypted.

13. The method as recited in claim 1, further comprising the step of receiving a post query disposition data from the potential customer via the interface, wherein the post query disposition data comprises a search identifier, a vendor identifier and an activity type.

14. The method as recited in claim 1, wherein:
the product inventory data comprises a vendor identifier, a drug name or code, a strength and a quantity available;
the normalized inventory data comprises the vendor identifier, the drug name or code, a generic equivalent name, the strength, a package size, and an inventory level based on the quantity available and the package size;
the product availability query comprises the drug name or code, a location, a flag indicating whether a generic equivalent is acceptable, a search results per page, a maximum number of search results and a user identifier;
the search results comprise a vendor name, a vendor location and a stock position;
the sales data comprises the vendor identifier, a sales date, a drug name or code, a quantity sold, a fill number and a customer identifier.

15. An apparatus comprising:
a communications interface;
a memory;
a database; and
a processor communicably coupled to the communications interface, the memory and the database wherein the processor:
receives a product inventory data from a vendor via the communications interface,
normalizes the received product inventory data,
stores the normalized product inventory data in the database(s),
receives a product availability query from the potential customer via the communications interface, wherein the product availability query comprises a requested product and a location,
obtains one or more search results by searching the database(s) for normalized product inventory data that best matches the requested product and the location,
provides the search results to the potential customer via the communications interface,
stores the product availability query and the search results in the database(s),
receives a product sales data from the vendor,
stores the received product sales data in the database(s),
determines whether a product sale resulted from the product availability query by calculating a match score based on the stored product sales data, the stored product availability queries and the stored search results, and
provides the match score to the vendor.

16. The apparatus as recited in claim 15, wherein:
the potential customer comprises a customer partner, a third party application, a clearinghouse, a third party website or an individual;
the interface comprises a query interface and a data interface;
the product availability query further comprises a quantity, a session identifier and one or more access control keys;
the vendor comprises a retailer, a wholesaler, a manufacturer or a distributor;
the database comprises a first database for the normalized product inventory data, a second database for the product sales data, and a third database for the product availability queries and the search results;
the product inventory data comprises a product name and a quantity available;
the requested product comprises the product name and a requested quantity;
the location comprises a zip code, an address, a GPS coordinate, or a latitude and a longitude;
the product sales data comprises the product name, a customer identifier, a sales date and a quantity sold; or
the match score comprises a number between 0 and 100 wherein 0 indicates no match found and 100 indicates a match was found with certainty.

17. The apparatus as recited in claim 15, wherein the search results are ranked based on the location, a quantity available or a combination thereof.

18. The apparatus as recited in claim 15, wherein the product inventory data and the product sales data are received in real-time or near real-time.

19. The apparatus as recited in claim 15, wherein the product sales data does not include any personal data.

20. The apparatus as recited in claim 15, wherein the processor further checks the product availability query for missing data or errors, and notifies the potential customer of the missing data or errors via the interface.

21. The apparatus as recited in claim 15, wherein the database(s) comprise an inventory database, an opportunity referral database and a sales database.

22. The apparatus as recited in claim 15, wherein the processor further excludes any sensitive data from the received product inventory data.

23. The apparatus as recited in claim 15, wherein the processor further converts a quantity of a product in inventory to an inventory level comprising a high level, a medium level, a low level and an out-of-stock level.

24. The apparatus as recited in claim 15, wherein the processor further receives a fee based on the match score whenever the potential customer is a new customer or an existing customer purchasing a new product.

25. The apparatus as recited in claim 15, wherein the match score is further based on:
a data consumer type;
a time between the search results and the product sale;
whether the product sale was for a new customer or an existing customer;
a frequency of sales for a product;
a number of refills for the product;
whether the product sale was preformed via a click-through event or an electronic transaction event;
whether the product availability query was generated by a device or a person;
whether previous product availability queries from the potential customer have been generated by a device or a person; or
whether the potential customer has previously been determined to purchase a product.

26. The apparatus as recited in claim 15, wherein all communications with the interface are encrypted.

27. The apparatus as recited in claim 15, wherein the processor further receives a post query disposition data from the potential customer via the interface, wherein the post query disposition data comprises a search identifier, a vendor identifier and an activity type.

28. The apparatus as recited in claim 15, wherein:
the product inventory data comprises a vendor identifier, a drug name or code, a strength and a quantity available;
the normalized inventory data comprises the vendor identifier, the drug name or code, a generic equivalent name, the strength, a package size, and an inventory level based on the quantity available and the package size;
the product availability query comprises the drug name or code, a location, a flag indicating whether a generic equivalent is acceptable, a search results per page, a maximum number of search results and a user identifier;
the search results comprise a vendor name, a vendor location and a stock position;
the sales data comprises the vendor identifier, a sales date, a drug name or code, a quantity sold, a fill number and a customer identifier.

29. A system comprising:
one or more potential customer devices;
one or more vendor devices;
one or more communication networks;
a data processing device comprising:
a communications interface communicably coupled to the one or more potential customer devices and the one or more vendor devices via the one or more communication networks,
a memory,
a database, and
a processor communicably coupled to the communications interface, the memory and the database wherein the processor:
receives a product inventory data from the vendor device via the communications interface,
normalizes the received product inventory data,
stores the normalized product inventory data in the database(s),
receives a product availability query from the potential customer device via the communications interface, wherein the product availability query comprises a requested product and a location,
obtains one or more search results by searching the database(s) for normalized product inventory data that best matches the requested product and the location,
provides the search results to the potential customer device via the communications interface,
stores the product availability query and the search results in the database(s),
receives a product sales data from the vendor device,
stores the received product sales data in the database(s),
determines whether a product sale resulted from the product availability query by calculating a match score based on the stored product sales data, the stored product availability queries and the stored search results, and
provides the match score to the vendor device.

30. The system as recited in claim 29, wherein:
the potential customer comprises a customer partner, a third party application, a clearinghouse, a third party website or an individual;
the interface comprises a query interface and a data interface;
the product availability query further comprises a quantity, a session identifier and one or more access control keys;
the vendor comprises a retailer, a wholesaler, a manufacturer or a distributor;
the database comprises a first database for the normalized product inventory data, a second database for the product sales data, and a third database for the product availability queries and the search results;
the product inventory data comprises a product name and a quantity available;
the requested product comprises the product name and a requested quantity;
the location comprises a zip code, an address, a GPS coordinate, or a latitude and a longitude;
the product sales data comprises the product name, a customer identifier, a sales date and a quantity sold; or
the match score comprises a number between 0 and 100 wherein 0 indicates no match found and 100 indicates a match was found with certainty.

31. The system as recited in claim 29, wherein the search results are ranked based on the location, a quantity available or a combination thereof.

32. The system as recited in claim 29, wherein the product inventory data and the product sales data are received in real-time or near real-time.

33. The system as recited in claim 29, wherein the product sales data does not include any personal data.

34. The system as recited in claim 29, wherein the processor further checks the product availability query for missing data or errors, and notifies the potential customer of the missing data or errors via the interface.

35. The system as recited in claim 29, wherein the database(s) comprise an inventory database, an opportunity referral database and a sales database.

36. The system as recited in claim 29, wherein the processor further excludes any sensitive data from the received product inventory data.

37. The system as recited in claim 29, wherein the processor further converts a quantity of a product in inventory to an inventory level comprising a high level, a medium level, a low level and an out-of-stock level.

38. The system as recited in claim 29, wherein the processor further receives a fee based on the match score whenever the potential customer is a new customer or an existing customer purchasing a new product.

39. The system as recited in claim 29, wherein the match score is further based on:
a data consumer type;
a time between the search results and the product sale;
whether the product sale was for a new customer or an existing customer;
a frequency of sales for a product;
a number of refills for the product;
whether the product sale was preformed via a click-through event or an electronic transaction event;
whether the product availability query was generated by a device or a person;
whether previous product availability queries from the potential customer have been generated by a device or a person; or
whether the potential customer has previously been determined to purchase a product.

40. The system as recited in claim 29, wherein all communications with the interface are encrypted.

41. The system as recited in claim 29, wherein the processor further receives a post query disposition data from the potential customer via the interface, wherein the post query disposition data comprises a search identifier, a vendor identifier and an activity type.

42. The system as recited in claim 29, wherein:
the product inventory data comprises a vendor identifier, a drug name or code, a strength and a quantity available;
the normalized inventory data comprises the vendor identifier, the drug name or code, a generic equivalent name, the strength, a package size, and an inventory level based on the quantity available and the package size;
the product availability query comprises the drug name or code, a location, a flag indicating whether a generic equivalent is acceptable, a search results per page, a maximum number of search results and a user identifier;
the search results comprise a vendor name, a vendor location and a stock position;
the sales data comprises the vendor identifier, a sales date, a drug name or code, a quantity sold, a fill number and a customer identifier.

43. A computer program embodied on a non-transitory computer readable medium for matching sales leads to purchases when executed by a computer having an interface, a database and a processor communicably coupled to the interface and one or more databases, the computer program comprising:
a code segment for receiving a product inventory data from a vendor via the interface;
a code segment for normalizing the received product inventory data; a code segment for storing the normalized product inventory data in the database(s);
a code segment for receiving a product availability query from a potential customer via the interface, wherein the product availability query comprises a requested product and a location;
a code segment for obtaining one or more search results by searching the database(s) for the normalized product inventory data that best matches the requested product and the location;
a code segment for providing the search results to the potential customer via the interface;
a code segment for storing the product availability query and the search results in the database(s);
a code segment for receiving a product sales data from the vendor;
a code segment for storing the received product sales data in the database(s);
a code segment for determining whether a product sale resulted from the product availability query by calculating a match score based on the stored product sales data, the stored product availability queries and the stored search results; and
a code segment for providing the match score to the vendor.
